(19) United States
(12) Patent Application Publication
(10) Pub. No.: US 2010/0046686 A1
(43) Pub. Date: Feb. 25, 2010

(54) METHOD FOR DOWNHOLE, NON-ISOTOPIC GENERATION OF NEUTRONS AND AN APPARATUS FOR USE WHEN PRACTISING THE METHOD

(76) Inventor: Phil Teague, Stavanger (NO)

Correspondence Address: OSTROLENK FABER GERB & SOFFEN, 1180 AVENUE OF THE AMERICAS, NEW YORK, NY, 100368403, US

(21) Appl. No.: 12/515,460

(22) PCT Filed: Nov. 19, 2007
(86) PCT No.: PCT/NO2007/000407

§ 371 Date: Jun. 18, 2009

(30) Foreign Application Priority Data
Nov. 20, 2006 (NO) 20065325

(51) Int. Cl. G01V 5/10; H05H 3/06

(52) U.S. Cl. 376/104; 376/118

(57) ABSTRACT

A method for downhole generation of non-radioactive neutron radiation arranged so as to be able to generate reverberation, particularly gamma radiation, from the surroundings of a borehole, the method comprising the steps of:

exciting laser light in a multistage laser light booster by means of a pump-type laser light source so as to form a pulsed laser light, the incoming light energy being concentrated in restricted laser light pulses representing a higher amount of light energy than that of the continuous flux of laser light;

forming a drop of a neutron-enriched fluid within a space in a vacuum chamber;

focusing the pulsed secondary laser light rays, which are directed toward the drop from substantially diametrically opposite directions, at a point in the drop, the drop consequently being compressed and heated so as to cause the neutron-enriched fluid in the drop to emit neutron radiation to the surroundings,

thereby forming a high-energy reverberation, at least in the gamma frequency range, from the surroundings.

An apparatus for use when practising the method.

The invention concerns a method for downhole, non-isotopic generation of neutrons, particularly in exploration—and production wells for oil, gas and water. The invention also concerns an apparatus for use when practising the method.

According to prior art, when carrying out downhole logging and gathering of material data, radioactive isotopes are used extensively. The disadvantages of this technique include the radiation danger caused by radioactive isotopes and, as a consequence, costly and demanding handling of isotopes and radioactive waste both at the installations where the drilling is carried out, and at the associated supply—and service facilities.

The object of the invention is to remedy or to reduce at least one of the disadvantages of the prior art.

The object is achieved by virtue of features disclosed in the following description and in the subsequent claims.

The object of the invention is to provide a method for non-isotopic generation of neutrons and an apparatus for use when practising the method.

The object of the invention is achieved by virtue of a method in which neutrons are provided in a non-radioactive manner by subjecting a drop of neutron-enriched fluid to a pulsed laser light from two directions. Dosed from a reservoir via a fine dosing device and into a restricted space in a pressure chamber pipe, the drop is provided in a vacuum chamber. The pulsed laser light is directed toward each end of the pressure chamber pipe where the light rays are focussed in the drop. The simultaneous influence of pulsed light on the drop induces a shock wave in the drop causing the drop to be compressed and heated. Some of the atomic nuclei in the drop emit neutrons that are used for irradiating the atomic structure of the surroundings, particularly in a borehole. The neutron-irradiated atoms emit gamma rays, which may be registered by a detector shielded against direct neutron irradiation from the irradiated drop.

The provision of neutron radiation according to the invention may occur at great intensity and when required. Consequently, the output power of such a manner of providing neutron radiation is many times greater than that experienced when using radioactive isotopes, which results in a strong reduction in the time consumed for logging a particular amount of data, which in turn results in a cost reduction. The method does not involve use of radioactive isotopes, thus eliminating the extensive checks, safety measures etc. used when handling radioactive isotopes and radioactive waste materials.

The apparatus used for practising the method of the invention exhibits a combination of known and new techniques within the fields of electronics, optoelectronics and physics.

The ability to provide high-intensive neutron radiation when required down in a borehole, and without having to use radioactive materials, will prove very advantageous within the oil—and gas industry when logging is to be carried out, for example of a subsurface structure.

More particularly, in a first aspect the invention concerns a method for downhole generation of non-radioactive neutron radiation arranged so as to be able to generate reverberation, particularly gamma radiation, from the surroundings of a borehole, characterized in that the method comprises the steps of:

forming a laser light;

directing the laser light into a multistage booster;

exciting the laser light by means of a pump-type laser light source so as to form a pulsed laser light, the incoming light energy being concentrated in restricted laser light pulses representing a higher amount of light energy than that of the continuous flux of laser light;

directing the pulsed primary laser light ray through a light ray splitter in order to form two pulsed secondary laser light rays having substantially the same frequency, energy content and phase;

forming a drop of a neutron-enriched fluid within a space in a vacuum chamber;

focussing the pulsed secondary laser light rays, which are directed toward the drop from substantially diametrically opposite directions, at a point in the drop, the drop consequently being compressed and heated so as to cause the neutron-enriched fluid in the drop to emit neutron radiation to the surroundings,

thereby forming a high-energy reverberation, at least in the gamma frequency range, from the surroundings.

Preferably, the pulsed laser light exhibits a frequency in the femtosecond range.

Preferably, the drop of neutron-enriched fluid is formed by dosing the fluid into a compression pipe.

Preferably, the neutron-enriched fluid is selected from the group consisting of heavy water (²H₂O), compressed and gaseous of ⁶He- or ⁸He-compounds, and naturally formed helium components, for example ⁷Li- or ¹¹Li.

In a second aspect, the invention concerns an apparatus for downhole generation of non-radioactive neutron radiation arranged so as to be able to generate reverberation, particularly gamma radiation, from the surroundings of a borehole, characterized in that the apparatus comprises:

a laser light source;

a multistage booster;

a pulse-type laser light source connected to the booster and collectively being arranged so as to be able to form a is pulsed laser light, the energy of the restricted laser light pulses representing a higher amount of light energy than that of a continuous flux of laser light formed by the laser light source;

a light ray splitter arranged so as to be able to split the pulsed primary laser light ray into two pulsed secondary laser light rays having substantially the same frequency, energy content and phase;

a vacuum chamber comprising one or several means arranged so as to be able to form a drop of neutron-enriched fluid;

means arranged so as to be able to direct the laser light from the laser light source to the drop via the booster and the light ray splitter;

means arranged so as to be able to restrict the motion of the drop when influenced by the pulsed secondary laser light rays;

means arranged so as to be able to focus, from two diametrically opposite directions, the pulsed secondary laser light rays at a point in the drop of the neutron-enriched fluid; and

means arranged so as to be able to emit neutron radiation to the surroundings encircling the apparatus, the neutron radiation being formed by virtue of the pulsed secondary laser light rays compressing and heating the drop consisting of the neutron-enriched fluid.

Preferably, the pulse-type laser light source (13) is arranged so as to be able to form the pulsed laser light at a frequency in the femtosecond range (10⁻¹⁵ sec).

Preferably, the means arranged so as to be able to direct the laser light is comprised of a plurality of mirrors. Alternatively, the means arranged so as to be able to direct the laser light is comprised of fibre-optics.

Preferably, the means arranged so as to be able to focus the pulsed secondary laser light rays at a point in the drop of the neutron-enriched fluid is concave mirrors. Alternatively, the means arranged so as to be able to focus the pulsed secondary laser light rays at a point in the drop of the neutron-enriched fluid is a lens arrangement.

Preferably, the means arranged so as to be able to restrict the motion of the drop when influenced by the pulsed secondary laser light rays is comprised of a compression pipe.

Advantageously, the compression pipe is provided with two end openings and a fluid supply opening arranged between the two end openings.

An example of a preferred embodiment is described in the following and is depicted in the accompanying drawings, in which:

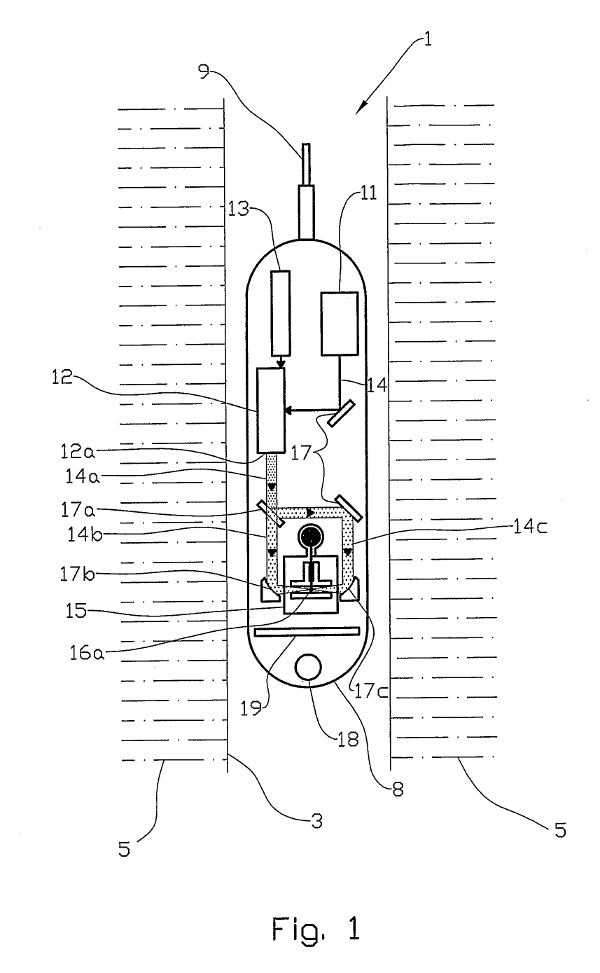

FIG. 1 shows an apparatus according to the invention placed in a borehole;

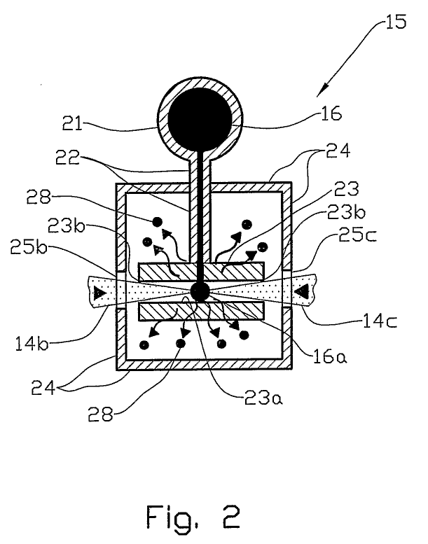

FIG. 2 shows, in larger scale, a vacuum chamber having a fluid reservoir and a pressure chamber pipe.

Reference is first made to FIG. 1 in which an apparatus according to the invention, as denoted with the reference numeral 1, is placed in a borehole 3 in a subsurface structure 5.

The apparatus 1 is provided with an outer jacket 8 connected to a device known per se (not shown) for positioning and displacement of the apparatus in the borehole 3 via a cable 9.

The apparatus 1 is provided with a laser light source 11 arranged so as to be able to provide a light ray 14, a multistage laser light booster 12, a pump-type laser light source 13 which is arranged, in cooperation with the laser light booster 12, to boost the light ray 14 and to provide a pulsed laser light 14a, which has a frequency in the femtosecond range, from the output 12a of the laser light booster 12. The apparatus 1 is further provided with a vacuum chamber 15 which, as described in further detail below, is provided with means for allowing a drop 16a (see FIG. 2) of a neutron-enriched fluid 16 (see FIG. 2) to be formed. A light ray splitter 17a is provided and arranged so as to be able to split the pulsed laser light 14a into two pulsed laser light rays 14b, 14c. Several mirrors 17 are provided in a manner in which they are arranged so as to be able to direct the laser light 14, 14a, 14c from the laser light source 11 to the laser light booster 12, from the laser light booster 12 to the light ray splitter 17a and further to means arranged so as to be able to focus, from two diametrically opposite directions, the two pulsed laser light rays 14b, 14c at a point in the drop 16a, for example by means of concave mirrors 17b, 17c, as shown herein.

The apparatus 1 further comprises a detector 18 which is arranged, in a manner known per se, so as to be able to detect ionised radiation, particularly gamma radiation, from the surroundings, more specifically from the subsurface structure 5 subject to logging. By means of a shield 19, the detector 18 is protected against the influence of direct neutron radiation 28 (see FIG. 2) from the radiation source of the apparatus 1, the radiation source being the pulsed-light-affected drop 16a of the neutron-enriched fluid 16 (see FIG. 2).

The apparatus 1 also comprises signal-communicating means (not shown) for signal transmission between the active units 11, 12, 13, 15, 18 in the apparatus 1, or between one or several of said units and control—and registration units (not shown) on the surface. These means may be comprised of wires, but it is obvious to a person skilled in the area that wireless transmission also may be suitable.

Reference is now made to FIG. 2, in which a more detailed presentation shows the vacuum chamber 15. In a manner known per se, the vacuum chamber 15 is arranged to maintain an internally specified, suitable negative pressure, the walls 24 of the vacuum chamber 15 being joined in a pressure-sealing manner, and the required fluid-conduit-conveying conduit bushings also being pressure-sealing. The vacuum chamber 15 comprises windows 25 permeable to radiation in the form of pulsed laser light 14a and neutron radiation 28.

A fluid reservoir 21 is connected to the vacuum chamber 15 via a dosing device 22 (shown schematically) arranged so as to be able to dose, in a controlled manner, a restricted amount of a neutron-enriched fluid 16 in the form of a drop 16a into a compression pipe 23. The drop 16a is enclosed by the wall 23a of the compression pipe 23 and the mouth of the dosing device 22. The drop 16a exhibit a free surface toward the two end openings 23b of the compression pipe.

The dosing device 22 is connected to a control device (not shown) arranged for directed control of the fluid dosing into the compression pipe 23. The fluid dosing device 22 is arranged so as to be able to close, in a pressure -sealing manner, the connection between the compression pipe 23 and the fluid reservoir 21.

When a drop 16a is provided in the compression pipe 23, it is possible for it to be compressed in response to pressure influence via the two end openings 23b of the compression pipe, which is due to the enclosing compression pipe wall 23a and the pressure-sealing connection between the compression pipe 23 and the fluid reservoir 21. The compression results, in a manner known per se, in heat generation in the drop 16a. According to the invention, the pressure influence is provided by virtue of the two pulsed laser light rays 14b, 14c inflicting, in a synchronised manner, “impact energy” onto the drop 16a. The inflicted energy causes the drop 16a to compress owing to the fact that it cannot escape from its enclosed position in the compression pipe 23.

The fluid 16 is neutron-enriched, preferably heavy water (²H₂O), but also compressed and gaseous ⁶He- or ⁸He-compounds, which are commonly known as neutron carriers, may be used. Naturally formed helium components, for example ⁷Li- or ¹¹Li, are also usable as a neutron source. The use of these alternative neutron sources has no principal significance for the construction and mode of operation of the apparatus 1.

When the drop 16a, which is provided in the compression pipe 23 by means of the dosing device 22, is illuminated simultaneous and from two sides with a pulse of the laser light 14b, 14c, a shock wave will arise in the drop 16a. This results in rapid compression and heating, which in turn leads to some neutrons being emitted from the atomic structure in the drop 16a. A neutron radiation 28 is thus formed and is directed toward the surroundings, i.e. the surrounding subsurface structure 5 of the borehole 3, generating reverberation in the form of gamma radiation, which may be detected by the detector 18.

Thus, in order to allow the subsurface structure 5 and the fluids contained therein to be mapped, the detected reverberation undergoes registering, storage and analysis in a normal manner.

It will be obvious to a person skilled in the area that the present method and apparatus for providing neutron radiation in accordance with the invention, is not limited only to logging operations, but to a number of areas having confine d space and limited possibilities for supply of energy.

It is also obvious to a skilled person that the present invention provides desired radiation intensity in a quick and risk-free manner. This allows a prescribed investigation to be carried out in a shorter time than that of using conventional, isotope-based methods. This, among other things, is because the radiation intensity may be increased without any risk to the surroundings, insofar as no radioactive isotopes are present requiring handling both before and after having carried out investigations of the types discussed herein.

1. A method for downhole generation of non-radioactive neutron radiation arranged so as to be able to generate reverberation, particularly gamma radiation, from the surroundings of a borehole, wherein the method comprises the steps of:
forming a laser light;
directing the laser light into a multistage laser light booster;
exciting the laser light by means of a pump-type laser light source so as to form a pulsed laser light, the incoming light energy being concentrated in restricted laser light pulses representing a higher amount of light energy than that of the continuous flux of laser light;
directing the pulsed primary laser light ray through a light ray splitter in order to form two pulsed secondary laser light rays having substantially the same frequency, energy content and phase;
forming a drop of a neutron-enriched fluid within a space in a vacuum chamber;
focusing the pulsed secondary laser light rays, which are directed toward the drop from substantially diametrically opposite directions, at a point in the drop, the drop consequently being compressed and heated so as to cause the neutron-enriched fluid in the drop to emit neutron radiation to the surroundings,
thereby forming a high-energy reverberation, at least in the gamma frequency range, from the surroundings.

2. The method according to claim 1, wherein the pulsed laser light exhibits a frequency in the femtosecond range.

3. The method according to claim 1, wherein the drop of neutron-enriched fluid is formed by dosing the fluid into a compression pipe.

4. The method according to claim 1, wherein the neutron-enriched fluid is selected from the group consisting of heavy water (²H₂O), compressed and gaseous ⁶He- or ⁸He-compounds, and naturally formed helium components, for example ⁷Li- or ¹¹Li.

5. An apparatus for downhole generation of non-radioactive neutron radiation arranged so as to be able to generate reverberation, particularly gamma radiation, from the surroundings of a borehole, wherein the apparatus comprises:
a laser light source;
a multistage booster;
a pulse-type laser light source connected to the booster and collectively being arranged so as to be able to form a pulsed laser light, the energy of the restricted laser light pulses representing a higher amount of light energy than that of a continuous flux of laser light formed by the laser light source;
a light ray splitter arranged so as to be able to split the pulsed primary laser light ray into two pulsed secondary laser light rays having substantially the same frequency, energy content and phase;
a vacuum chamber comprising one or several means arranged so as to be able to form a drop of neutron-enriched fluid;
means arranged so as to be able to direct the laser light from the laser light source to the drop via the booster and the light ray splitter;
means arranged so as to be able to restrict the motion of the drop when influenced by the pulsed secondary laser light rays;
means arranged so as to be able to focus, from two diametrically opposite directions, the pulsed secondary laser light rays at a point in the drop of the neutron-enriched fluid; and
means arranged so as to be able to emit neutron radiation to the surroundings encircling the apparatus, the neutron radiation being formed by virtue of the pulsed laser light rays compressing and heating the drop consisting of the neutron-enriched fluid.

6. The apparatus according to claim 5, that wherein the pulse-type laser light source is arranged so as to be able to form the pulsed laser light at a frequency in the femtosecond range (10⁻¹⁵ sec).

7. The apparatus according to claim 5, wherein the means arranged so as to be able to direct the laser light is comprised of a plurality of mirrors.

8. The apparatus according to claim 5, wherein the means arranged so as to be able to direct the laser light is comprised of fibre-optics.

9. The apparatus according to claim 5, wherein the means arranged so as to be able to focus the pulsed secondary laser light rays at a point in the drop(6 of the neutron-enriched fluid is concave mirrors.

10. The apparatus according to claim 5, wherein the means arranged so as to be able to focus the pulsed secondary laser light rays at a point in the drop of the neutron-enriched fluid is a lens arrangement.

11. The apparatus according to claim 5, wherein the means arranged so as to be able to restrict the motion of the drop when influenced by the pulsed secondary laser light rays is comprised of a compression pipe.

12. The apparatus according to claim 11, wherein the compression pipe is provided with two end openings and a fluid supply opening arranged between the two end openings of the compression pipe.
